(19) United States
(12) Patent Application Publication
(10) Pub. No.: US 2004/0119939 A1
(43) Pub. Date: Jun. 24, 2004

(54) Tinted contact lenses with color patterns having varying depths

(76) Inventors: Douglas G. Clark, Jacksonville, FL (US); Jerry W. Dukes, Jacksonville, FL (US); James R. Petisce, Jacksonville, FL (US)

Correspondence Address: PHILIP S. JOHNSON, JOHNSON & JOHNSON, ONE JOHNSON & JOHNSON PLAZA, NEW BRUNSWICK, NJ, 08933-7003, US

(21) Appl. No.: 10/323,264

(22) Filed: Dec. 19, 2002

(51) Int. Cl. G02C 7/04

(52) U.S. Cl. 351/162

(57) ABSTRACT

The invention provides tinted contact lenses that provide a more natural appearing iris than by using colorant layers of varying thicknesses.

### FIELD OF THE INVENTION

The invention relates to tinted contact lenses. In particular, the invention provides contact lenses that change the natural color of the lens wearer's iris.

### BACKGROUND OF THE INVENTION

The use of tinted, or colored, contact lenses to alter the natural color of the iris is well known. In tinted lenses, it is known to use either or both translucent and opaque colors in one or more layers of color with the object of creating a natural appearing tinted iris. Typically, the color layers are each applied at a single thickness. This provides color variation only with the use of multiple color layers or points at which a translucent color layer overlaps another color layer.

However, the natural iris is composed of a large number of different colors and color combinations intermixed to create color variations. The relatively small number of colors and color layers that may be used in producing tinted contact lenses limits the designer's ability to create a natural appearing lens. Thus, a need exists for a method of producing tinted contact lenses on which additional color variation may be economically achieved.

### BRIEF DESCRIPTION OF THE DRAWINGS

FIG. 1 is a scanned image of a plan view of a prior art embodiment of a multiple color layer pattern.

FIG. 2 is a scanned image of a plan view of a multiple color layer pattern of the invention.

### DETAILED DESCRIPTION OF THE INVENTION AND PREFERRED EMBODIMENTS

The invention provides tinted contact lenses, and methods for their manufacture, that alter the natural color of the lens wearer's iris. The lenses of the invention provide a more natural appearing iris than is obtainable by conventional manufacturing methods. It is a discovery of the invention that a more natural appearing tinting of the iris can be achieved by using colorant layers of varying thicknesses.

In one embodiment, the invention provides at least one surface of a contact lens comprising a base opaque or translucent layer having a first thickness and one or more additional color layers selected from the group consisting of a second translucent color layer, an opaque color layer, or a combination thereof, each of the additional color layers having a thickness that is different from that of the base layer. In a preferred embodiment, the thicknesses of at least one of the additional color layers is different from the thickness of the base layer as well as any of the other additional color layers. In yet another preferred embodiment, the thickness of the colorant for one or more of the layers varies within that layer.

For purposes of the invention, by “translucent” is meant a color that permits an average light transmittance (% T) in the 380 to 780 nm range of greater than or equal to about 60, preferably greater than or equal to about 65 percent T. By “opaque” is meant a color that permits an average light transmittance (% T) in the 380 to 780 nm range of 0 to about 55, preferably 7 to about 50 percent T.

In the lenses of the invention, when two or more translucent color layers of varying thicknesses are overlaid, or an opaque layer is overlaid with a translucent color layer, either partially or wholly, a variation of the color will be achieved that is different from that achieved using only the layer alone or layers of uniform thickness. Even more variation may be achieved by varying the thickness of the colorant within one or more of the layers.

The color achievable by this method may be approximated using the Beer/Lambert Law according to which:

A=e×c×l (I)

wherein

A is the absorbance of the colored material applied to the lens

e is the molar extinction coefficient of, or absorptivity;

c is the concentration of the color in moles/liter; and

l is the path length in mm.

The absorption spectrum of a color may be determined by a ultraviolet/visible spectrometer and plotting an absorbance versus wavelength. The molar extinction coefficient at any wavelength may be calculated as follows:

e=A/c×l (II)

Also, according to the Beer/Lambert Law:

A=−logT (III)

wherein transmittance (T) is according to the following Equation IV:

T=I/Iₒ (IV)

Iₒ being the intensity of the incident light impinging on a given solution or colored solid and I being the intensity of the incident light after it has passed through a given solution or colored solid.

From the extinction coefficient calculated from absorbance versus wavelength plot, and using Equations II and IV, the amount of light transmitted through a given solution or colored solution at any given wavelength can be calculated. Thus, using the simple mixing law, absorbance at wavelength q of a mixture of 2 components, F and G, may be calculated according to:

A_{q}=(e_{F×}c_{F})+(e_{G}×c_{G}) (V)

wherein

e_{F} and e_{G} are the extinction coefficients of components F and G, respectively, at wavelength q; and

c_{F} and c_{G} are the molar concentrations of components F and G, respectively.

One ordinarily skilled in the art will recognize that Equation V is to be use for transparent solutions and solids. For opaque solutions and solids, the Kubelka-Munk equation is used, which equation states:

K/S=(1−R)²/2R (VI)

wherein

K is the absorption coefficient;

S is the scattering coefficient; and

R is the reflectance.

For a mixture of two opaque colorants U and V, the following equation is used:

K/S=Kₘᵢₓₜᵤᵣₑ/Sₘᵢₓₜᵤᵣₑ=(c_{U}K_{U}+c_{V}K_{V})/(c_{V}S_{V}+c_{V}S_{V}) (VII)

wherein

c_{U} and c_{V} are the concentrations of colorants U and V, respectively.

The variation in color layer thickness from layer to layer may be achieved by any convenient method including, without limitation, varying the depth of the pattern for the layer etched into the cliche used to apply the pattern. Similarly, the depth within a pattern may be varied by etching certain patten elements more deeply than others. The color layers may be applied to either or both the back, or eye side, surface or the front, or object side, surface of the lens, but preferably all of the layers are applied to the front surface of the lens. Additionally, the layers may be applied, or printed, in any order. For example, the base layer may be applied behind a translucent and opaque layer or between one or more opaque layers. Preferably, the base layer is the outermost color layer on the surface of the lens. In yet another embodiment and preferably, a clear, pre-polymer layer may be used in conjunction with the color layers.

The color selected for each of the layers will be determined by the natural color of the lens wearer's iris and the color to which the natural color is to be changed. For example, the base layer may be any color including, without limitation, any of a variety of hues and chromas of blue, green, gray, brown, yellow, red, orange, violet, or combinations thereof. Additional color layers may be any color that complements the base layer color or is a shift of that color in terms of one or more of hue, chroma, and lightness.

The invention may be used to provide tinted hard or soft contact lenses made of any known lens-forming material, or material suitable for manufacturing such lenses. Preferably, the lenses of the invention are soft contact lenses the material selected for forming the lenses of the invention being any material suitable for producing soft contact lenses. Suitable preferred materials for forming soft contact lenses using the method of the invention include, without limitation, silicone elastomers, silicone-containing macromers including, without limitation, those disclosed in U.S. Pat. Nos. 5,371,147, 5,314,960, and 5,057,578 incorporated in their entireties herein by reference, hydrogels, silicone-containing hydrogels, and the like and combinations thereof. More preferably, the surface is a siloxane, or contains a siloxane functionality, including, without limitation, polydimethyl siloxane macromers, methacryloxypropyl polyalkyl siloxanes, and mixtures thereof, silicone hydrogel or a hydrogel, made of monomers containing hydroxy groups, carboxyl groups, or both or be made from silicone-containing polymers, such as siloxanes, hydrogels, silicone hydrogels, and combinations thereof. Materials for making soft contact lenses are well known and commercially available. Preferably, the material is acquafilcon, etafilcon, genfilcon, or lenefilcon.

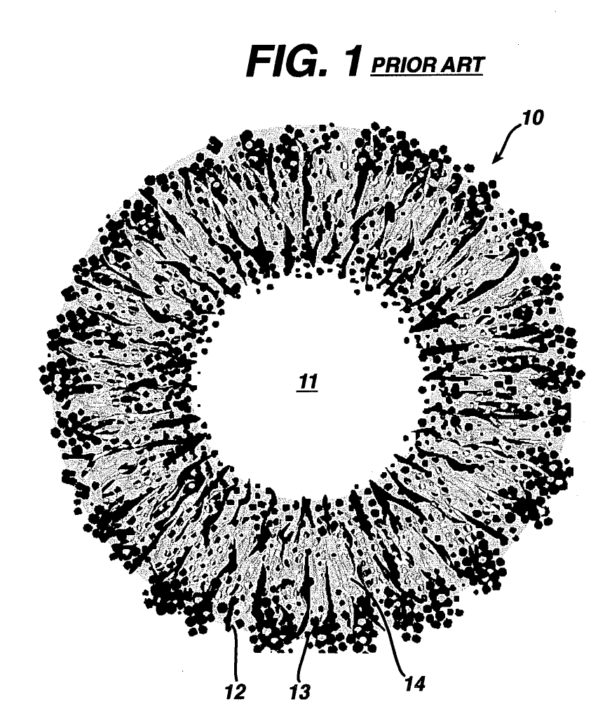

In FIG. 1 is depicted a conventional multi-layer color pattern 10 using color layers which are of uniform thickness. In the color pattern there is a clear central zone 11 of a diameter such that, when a soft lens to which the pattern is applied is in it hydrated state, zone 11 is approximately the same or a similar diameter to the lens wearer's pupil, which zone 11 will overlay. Generally, zone 11 will be about 4 to about 6 mm in diameter. Central area 11 is surrounded by multiple color layers 12, 13, and 14 that, when the lens is in a hydrated state, are of the same or similar in diameter to the lens wearer's iris. Typically, the color layers will be about 7 to about 13 mm in diameter. Each of layers 12, 13, and 14 are of the same depth both layer to layer and within each layer.

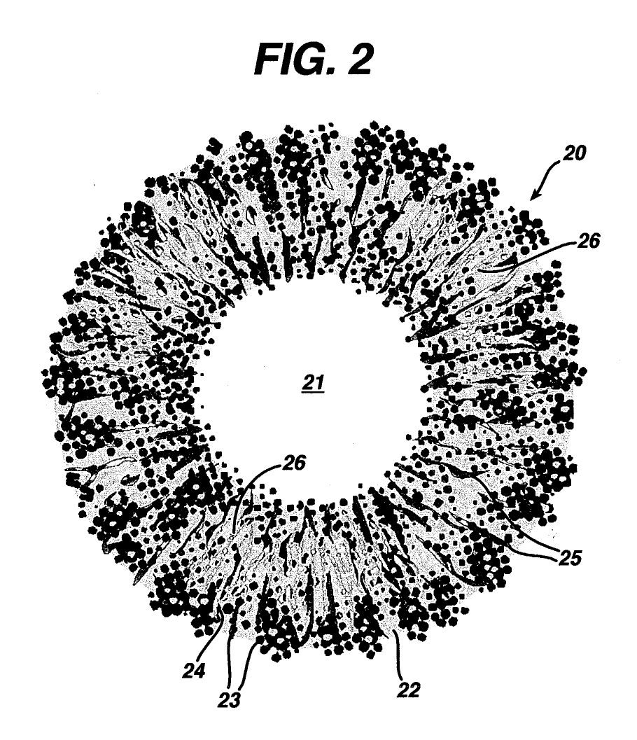

In FIG. 2 is shown a multi-layer color pattern 20 of the present invention. Translucent color layer 22 is of uniform thickness. An opaque color layer is also shown that varies in thickness within the layer as can be seen by comparing the darker dotted portions 23 of the layer with the lighter striations 25. A translucent color layer is also provided that varies in depth within the layer as seen by comparing the striations 24 to those striations 26 of the translucent layer.

One ordinarily skilled in the art will recognize that, by varying the color depth of an opaque color layer within that layer, a mixed opaque and translucent color layer my result. Thus, in yet another embodiment of the invention, a tinted lens having a color layer having both opaque and translucent color is provided.

In still another embodiment of the invention, color layers may be used in which the color varies in thickness layer to layer. As yet another alternative, each color layer may be of a different thickness and the color of one or more of the layers may be radially gradient, meaning that the color thickness varies as one moves from the center to the periphery of the color layer. The variation may be one or both of an increase or a decrease in color density. As yet another alternative, one or more of the color layers may contain a plurality of clear or colored areas that may be of any shape including, without limitation, circles, ovals, triangles, lines, striae, feather-like shapes, and the like, and combinations thereof. The colors to be used in the base layer will be selected depending on the natural color of the lens wearer's iris and the color to which the wearer wishes to change the iris.

The color zones of the color layers may be made from any organic or inorganic pigment suitable for use in contact lenses, or combinations of such pigments. The opacity may be controlled by varying the concentration of the pigment and titanium dioxide used, with higher amounts yielding greater opacity. Illustrative organic pigments include, without limitation, pthalocyanine blue, pthalocyanine green, carbazole violet, vat orange #1, and the like and combinations thereof. Examples of useful inorganic pigments include, without limitation, iron oxide black, iron oxide brown, iron oxide yellow, iron oxide red, titanium dioxide, and the like, and combinations thereof. In addition to these pigments, soluble and non-soluble dyes may be used including, without limitation, dichlorotriazine and vinyl sulfone-based dyes. Useful dyes and pigments are commercially available.

The dye or pigment selected may be combined with one or more of a pre-polymer, or binding polymer, and a solvent to form the colorant used to produce the translucent and opaque layers used in the lenses of the invention. The pre-polymer may be any polymer that is capable of dispersing the pigment and any opacifying agent used. Other additives useful in contact lens colorants also may be used. The binding polymers, solvents, and other additives useful in the color layers of the invention are known and either commercially available or methods for their making are known.

In addition to the first base layer, one or more additional color layers are used. The additional layers may be one or more translucent color layers, one or more layers of opaque color, or combinations thereof. In preferred embodiments, one opaque layer is used in combination with two or more translucent layers. Each of the additional color layers must be of a color that is the same as, similar to, or complementary to, the color of the base layer and aids in achieving the color change desired for the natural iris.

Preferably, the lenses of the invention are worn on-eye, greater than about 85 %, preferably equal to or greater than about 90%, of the area of the iris is covered the combination of the color zones of all of the color layers used. This is advantageous in that a color change to the iris may be imparted without either blocking the natural iris structure or having an impact on visual performance while providing an appearance of depth within the pattern. Additionally, using the color layers of the invention, even the color of the darkest colored on irises may be changed. The base layer color zone coverage preferably is about 85 to about 99 percent. The total coverage imparted by the color zones of the additional color layers preferably is about 40 to about 70 percent.

The layers used in the lenses of the invention are applied to, or printed on, the lens surface by any convenient method. In a preferred method, a thermoplastic optical mold, made from any suitable material including, without limitation, cyclic polyolefins and polyolefins such as polypropylene or polystyrene resin is used. The color layers, such as the translucent base layer, are deposited onto the desired portion of the molding surface of the mold. By “molding surface” is meant the surface of a mold or mold half used to form a surface of a lens. The deposition preferably is carried out so that the outermost color layer on the lens surface will be the translucent base layer. Preferably, the deposition is carried out by pad printing as follows.

A metal plate, preferably made from steel and more preferably from stainless steel, is covered with a photo resist material that is capable of becoming water insoluble once cured. The pattern of the color layer is selected or designed and then reduced to the desired size using any of a number of techniques such as photographic techniques, placed over the metal plate, and the photo resist material is cured.

Following the pattern, the plate is subsequently washed with an aqueous solution and the resulting image is etched, by any suitable known method such as chemical etching, into the plate to a suitable depth. Alternatively, the pattern may be applied to the cliche by use of a laser. For layers of varying thicknesses, each layer is etched into the cliche at a different depth than for one or more of the other layers to be applied. Alternatively or additionally, the elements of the patter forming one layer may be etched into the cliche at varying depths. Any suitable depth may be used so long as the desired pattern is achieved in the lens. Typically, depths from layer to layer or within a pattern on layer from will be about 0.003 to about 0.040 mm, preferably about 0.005 to about 0.030 mm. A colorant containing a binding polymer, solvent, and pigment or dye is then deposited onto the pattern to fill the depressions with colorant. A silicon pad of a geometry suitable for use in printing on the surface and varying hardness, generally about 1 to about 10 Shore, is pressed against the image on the plate to remove the colorant and the colorant is then dried slightly by evaporation of the solvent. The pad is then pressed against the molding surface of an optical mold. Depending upon the colorant, lens material and cure conditions selected, the mold may be degassed for up to 12 hours to remove excess solvents and oxygen after which the mold is filled with lens material. A complementary mold half is then used to complete the mold assembly and the mold assembly is exposed to conditions suitable to cure the lens material used. Such conditions are well known in the art and will depend upon the lens material selected. Once curing is completed and the lens is released from the mold, it is equilibrated in a buffered saline solution.

The method of the invention may be used to create any number of tinted contact lens designs. However, the invention may find its greatest utility in limbal ring designs. A limbal ring design is any color pattern that augments or changes the color of the limbal area of the lens wearer. For example, the use of multiple depths may be used to simulate different levels of translucent color, opaque color, or both radially across the limbal ring. As another alternative, the limbal ring design may be a pattern containing a plurality of clear or colored areas that may be of any shape including, without limitation, circles, ovals, triangles, lines, striae, feather-like shapes, and the like, and combinations thereof wherein the layer containing these shapes may vary in depth within the layer or may be a different depth than other layers being used to provide the limbal ring design.

What is claimed is:

1. A tinted contact lens, comprising a base opaque or translucent layer having a first thickness and one or more additional color layers selected from the group consisting of a second translucent color layer, an opaque color layer, a color layer comprising translucent and opaque color, or a combination thereof, wherein each of the additional color layers has a thickness that is different from that of the base layer.

2. The lens of claim 1, wherein the thickness of at least one of the additional color layers is different from the thickness of the base layer and the thickness of the other additional color layers.

3. The lens of claim 1, wherein at least one of the base layer and additional color layers further comprises at least two different thicknesses within the layer.

4. The lens of claim 1, wherein the color layers are applied to a back surface of the lens.

5. The lens of claim 1, wherein the color layers are applied to a front surface of the lens.

6. The lens of claim 1, wherein the color layers are applied to a front and a back surface of the lens.

7. The lens of claim 1, further comprising a clear pre-polymer layer.

8. The lens of claim 1, 2 or 3, wherein the thickness of each layer to layer is about 0.003 to about 0.040 mm

9. The lens of claim 1, 2, or 3, wherein at least one layer comprises a limabl ring design.

10. A tinted contact lens, comprising a base opaque or translucent layer and one or more additional color layers selected from the group consisting of a second translucent color layer, an opaque color layer, a color layer comprising translucent and opaque color, or a combination thereof, wherein at least one of the layers comprises at least two thicknesses.

11. The lens of claim 10, wherein at least one of the layers has a thickness that is different from at least on other layer.

12. The lens of claim 10, wherein each color layer has a thickness that is different from each of the other layers.

13. The lens of claims, 10, 11, and 12, wherein the thickness within a layer is about 0.003 to about 0.040 mm.

14. The lens of claim 10, 11, or 12, wherein the layer comprising at least two thickneses further comprises a limbal ring design.
